(19) United States
(12) Patent Application Publication
(10) Pub. No.: US 2006/0168378 A1
(43) Pub. Date: Jul. 27, 2006

(54) Method and chip unit for addressing and/or activating a user of a serial data bus

(76) Inventor: Matthias Muth, Stelle (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/517,673

(22) PCT Filed: Jun. 5, 2003
(86) PCT No.: PCT/IB03/02115

§ 371 Date: Jul. 11, 2005

(30) Foreign Application Priority Data
Jun. 10, 2002 (DE) 102 25 578.4

(51) Int. Cl. G06F 7/00

(52) U.S. Cl. 710/106; 701/36

(57) ABSTRACT

To further develop a method and a chip unit (30) for addressing and/or activating at least one user (40) that is associated with at least one data base (10), in particular at least one C[ontroller] A[rea] N[etwork] bus, and is intended to carry out at least one application, in such a way that individual users (40) on the network, i.e. individual users (40) on the data bus (10), can be woken selectively and in a targeted manner so that individual subnetworks can be formed in this way as and when required without the need for the whole network to be woken up, it is proposed that in the event of at least one incoming message occurring on the data bus (10), at least one protocol controller unit (42) associated with the user (40) is supplied with voltage first.

The present invention relates to a method of addressing and/or activating at least one user that is associated with at least one serial data bus, in particular at least one C[ontroller] A[rea] N[etwork] bus, and is intended to carry out at least one application.

The present invention further relates to a chip unit, particularly a system chip unit, for addressing and/or activating at least one user that is associated with at least one serial data bus, in particular at least one C[ontroller] A[rea] N[etwork] bus, and is intended to carry out at least one application.

As complexity increases in serial networking, particularly in automobiles, so too is there a greater and greater increase in the energy required by the electronic components used in the serial networking. Added to this is the fact that more and more functions aimed at providing comfort and convenience are active even when the motor vehicle is parked and then have to be operated directly from the vehicle's battery.

Because a large number of functions are serially networked via for example the C[ontroller] A[rea] N[etwork] bus, it is always the entire bus system that is activated even when there are only a few vehicle functions operating, due to the fact that each user on the bus is “woken up” or “kept awake” by the transmission of data by these few users. This causes a current consumption by the system that is undesirably high and, given that only a few vehicle functions are operating, one that is even quite unnecessary.

In the prior art, there are now known methods in which all the users are first woken up by a global wake-up. After this, as many users as desired can be changed back to the sleeping state, from which they can only be woken again by means of a separately defined waking symbol or by means of a special level scheme.

Something that is disadvantageous in this case however is that all the nodes have to be woken up first before a subnetwork is set up by switching off the ones that are not required. At least for a short time this causes a high current consumption, which is a great nuisance, particularly with cyclic wake-up processes.

In another method, each data packet on the bus is analyzed by special hardware to allow a decision to be made as to whether the message is relevant to a sleeping, and thus switched-off, node. Only if the comparison of the message in question with a predefined message is successful is the application woken up and started. One of the things that is disadvantageous in this case however is that a second bus protocol controller, which has a continuous power supply, is required to monitor the bus, using a complex filter for the messages, and to search it for relevant messages.

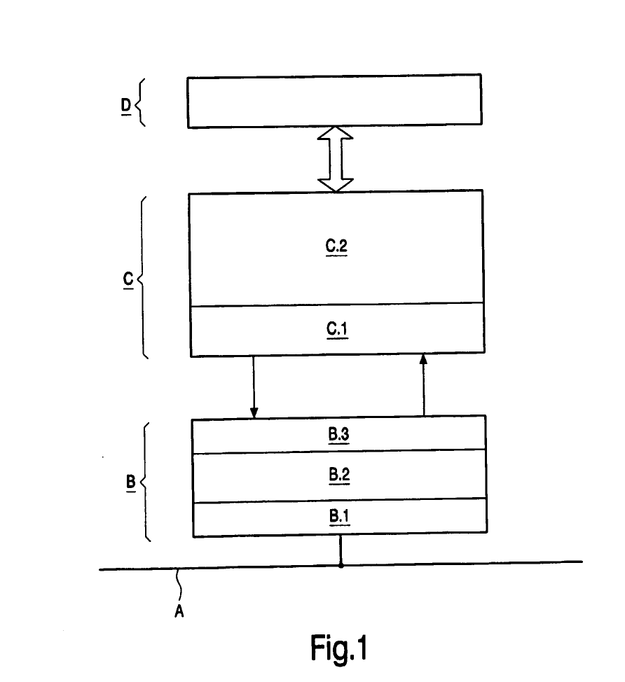

FIG. 1 shows an illustrative embodiment of a prior art C[ontroller] A[rea] N[etwork] system of this kind intended for CAN applications in automobiles.

The system chip B analyzes the data traffic on the serial CAN bus A by means of a CAN transceiver B.1 and by means of its own CAN controller (including a quartz oscillator) B.2, whereas the application microcontroller (including a quartz oscillator) C.2 and the application hardware D can be switched off to save current on the system.

However, a second application CAN controller C.1 is required in this case and this needs to operate very accurately (which is why a separate quartz oscillator and a separate CAN controller are required) so that incorrect decisions will not be made as a result of the sort of faults that typically occur in automobiles. If the message comparator B.3 has found the predefined wake-up message, the application D is activated and supplied with current. However, an implementation of this complicated kind is generally very expensive.

Taking the disadvantages and shortcomings described above as a point of departure and with due allowance for the prior art outlined, it is an object of the present invention so to further develop a method of the kind detailed in the first paragraph and a chip unit of the kind detailed in the second paragraph that individual users on the network, that is to say individual users on the data bus, can be selectively woken in a targeted manner, in order in this way to be able to form individual subnetworks as and when required without having to wake up the entire network.

This object is achieved by a method having the features specified in claim 1 and by a chip unit having the features specified in claim 8. Advantageous embodiments and useful refinements of the present invention are described in the respective sets of dependent claims.

The present invention is thus based on the principle of subnetwork operation by selective waking. It is possible in this case, under the teaching of the present invention, to avoid the duplication of the protocol controller hardware that is mandatory in the prior art by using the protocol controller (hereinafter also referred to as protocol controller unit) that is already present in the application controller (hereinafter also referred to as application controller unit) and providing it with a partial supply from the system chip or some other item of hardware only when there is traffic present on the serial data bus system at the time. For the exchange of signals between the system chip and the application controller, use is made in this case of the connections that are present anyway, and there is thus no further external burden that has to be operated.

With regard to the procedure followed in the method according to the present invention, the voltage supply to the protocol controller is provided by at least one upstream transceiver (hereinafter also referred to as transceiver unit) or by the system chip (hereinbefore and hereinafter also referred to as chip unit or system chip unit) whenever messages occur on the data bus (the term “messages” is intended in this case to cover not only messages but also communications and/or data packets occurring on the data bus).

A fact that has an advantageous effect in this case is that the protocol controller may, on a C[ontroller] A[rea] N[etwork] basis for example, be separately supplied within the application by following a system. The protocol controller itself may form a stand-alone device or may be incorporated in the microcontroller.

In a particularly inventive embodiment, the separately supplied protocol controller, which may usefully have a clock signal of its own suited to the requirements that exist, may compare the incoming messages that occur with stored reference messages, with at least one message filtering unit being available within the protocol controller for the purposes of this comparison of messages.

The protocol controller only sends an acknowledgement to the upstream transceiver or the upstream system chip if the comparison proves positive. Only in the event of a suitably positive acknowledgement of this kind from the protocol controller does the upstream transceiver or the upstream system chip then provide the application and its microcontroller with a supply.

The present invention further relates to a transceiver unit for carrying out the method of the type described above. The transceiver unit is connected to the databus and is in communication with the protocol controller unit and with the application controller unit.

According to a preferred further development of the present invention, at least one control logic is associated with the transceiver unit and/or at least one control logic is implemented in the transceiver unit.

The present invention further relates to a first voltage regulator which is connected to at least one battery unit and which is in communication with at least one transceiver unit, in particular of the type described above, which voltage regulator is intended to supply a voltage to at least one protocol controller unit, which is associated with at least one user provided for carrying out at least one application, in the event of at least one incoming message that occurs on at least one serial databus, in particular on at least one C[ontroller]A[rea]N[etwork] bus.

The present invention further relates to a second voltage regulator which is connected to at least one battery unit and which is in communication with at least one transceiver unit, in particular of the type described above, which second voltage regulator is intended to supply a voltage to at least one application controller unit, which is associated with at least one user provided for carrying out at least one application, in the event of a correspondence and/or match between at least one incoming message that occurs on at least one serial databus, in particular on at least one C[ontroller]A[rea]N[etwork] bus, and at least one reference message stored in at least one protocol controller unit and associated with the application.

The chip unit, in particular system chip unit, in accordance with the present invention comprises
at least one transceiver unit of the type described above,
at least one first voltage regulator of the type described above, and
at least one second voltage regulator of the type described above.

The present invention further relates to a protocol controller unit for comparing at least one incoming message which occurs on at least one databus with at least one stored reference message which is associated with at least one application to be carried out by at least one user, in particular by means of a message comparator and/or message filter of the type described above. In the event of one or more incoming messages, the protocol controller unit must be first supplied with a voltage.

According to a preferred further development of the present invention, the protocol controller unit comprises at least one timing generator, in particular a quartz unit, which enables the protocol controller unit to usefully have timing of its own, in particular quartz timing.

The present invention further relates to an application controller unit of the type described above. The application controller unit is to be supplied with a voltage only in the event of a correspondence and/or match between at least one incoming message that occurs on at least one databus and at least one stored reference message associated with at least one application to be carried out by at least one user.

According to a preferred further development of the present invention, the application controller unit may be activated by at least one transceiver unit, in particular of the type described above.

The present invention further relates to a user of the type describes above, which is provided to carry out at least one application and which is associated with at least one databus, comprising
at least one protocol controller unit of the type described above, and
at least one application controller unit of the type described above.

The present invention further relates to a system of the type described above, comprising
at least one chip unit of the type described above, and
at least one user of the type described above, the chip unit and the user being in communication with one another.

Finally, the present invention relates to the use of a method of the kind described above and/or of at least one chip unit of the kind described above for addressing and/or activating at least one user in automobile electronics and particularly in the electronics of motor vehicles that is associated with at least one data bus and is intended to carry out at least one application.

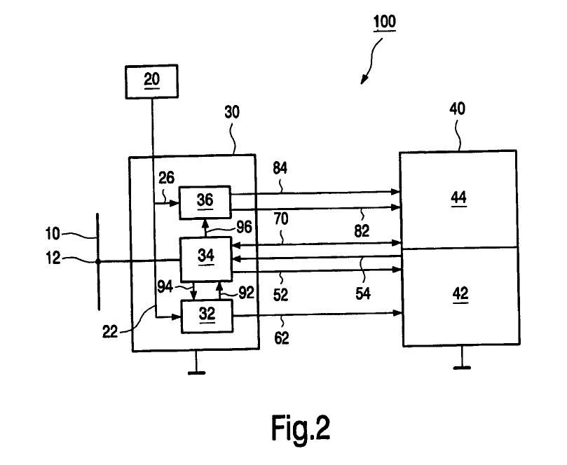

As has already been described above, there are various possible ways in which the teaching of the present invention may advantageously be embodied and refined. On the one hand, reference can be made in this connection to the claims dependent on claims 1, 4, 9 and 11, and on the other, further aspects, features and advantages of the present invention are apparent from and will be elucidated with reference to the illustrative embodiment shown in FIG. 2 and described hereinafter.

In the drawings:

FIG. 1 is a block diagram of a prior art embodiment of system having a chip unit and a microcontroller unit, and

FIG. 2 is a block diagram of an embodiment of system based on the method of the present invention and having a chip unit and a microcontroller unit according to the present invention.

Shown diagrammatically in FIG. 2 is a system 100 by means of which a user 40, which is intended to carry out an application and is connected to a node 12 on a serial C[ontroller] A[rea] N[etwork] data bus 10, can be addressed and activated. The principle on which the system 100 operates in this case is as follows:

If messages traffic arises and is detected on the CAN data-bus line 10, a transceiver 34 that is connected to the data bus 10 and fitted with control logic, or the system chip unit 30 that contains the transceiver unit 34, to which transceiver 34 or system chip unit 30 there is a permanent supply from a battery unit 20, switches on a first voltage regulator 32 that is connected to the transceiver unit 34 by connections 92, 94 and whose purpose is to supply current to a protocol controller unit 42 that is associated with the application user 40 and that has a clock signal of its own that is suited to requirements. For this purpose, the first voltage regulator 32 is connected to the battery unit 20.

Via a receive line (=RXD line 52), which connects the transceiver unit 34 and the protocol controller unit 42 together, the bit stream is passed on to the protocol controller unit 42, where it is analyzed. In the protocol controller unit 42, there then takes place, by means of a message comparator or message filter, a comparison of the received messages or data packets with stored reference messages or data packets.

Because of the availability of the quartz-controlled clock signal (from the quartz oscillator unit in the protocol controller unit 42) and of the protocol hardware, the detection of certain messages or data packets can take place with great accuracy. However, because there is not as yet any supply to the application itself, including the application microcontroller 44, there is a considerable saving of current in this case.

If the result of the comparison is positive, the protocol controller unit 42 transmits a feedback signal to the transceiver unit 34, i.e. to the system chip unit 30, via a transmission line (=TXD connection 54). A second voltage regulator 36, which, via a feed line 26, is likewise connected to the battery unit 20 and which is connected to the transceiver unit 34 by a connection 96, is then switched on and the application is fully started via the connecting line 82 as a result of voltage being supplied from the second voltage regulator 36 to the application controller unit 44 associated with the user 40. As can also be seen from what is shown in FIG. 2, there is also a reset line 84 (“reset”) that runs between the second voltage regulator 36 and the application microcontroller unit 44.

If, on the other hand, no message is detected, this is to say if the incoming message from the CAN bus 10 does not correspond to any of the reference messages associated with the application that are stored in the protocol controller unit 42, then the second voltage regulator 36 is not switched on.

Once there has been a quiescent state on the bus for a period of time that is preset in the system chip unit 30 or in the transceiver unit 34, the first voltage regulator 32 is switched off as well and current is saved to the maximum extent in this way. The system chip unit 30 or the transceiver unit 34 now draws its supply only from the battery unit 20 and waits for incoming messages from the CAN data bus 10 so that it can then switch the first voltage regulator 32 back on again.

The system 100 can be configured and controlled via a mode control interface 70 between the transceiver unit 34 (or the system chip unit 30) and the application controller unit 44.

One further point that should be made in connection with the embodiment that has been elucidated by reference to FIG. 2 is that it is irrelevant for the purposes of implementation whether it is an integrated system chip 30 that is used, or discrete components, such as a transceiver 34 and voltage regulators 32, 36. It is also irrelevant whether the protocol controller 42 is incorporated in the microcontroller or is implemented in the form of a stand-alone device.

So, to sum up, it can be said that the system 100 shown in FIG. 2 is designed to address and activate users 40 that are associated with a serial data-bus system 10 and are each intended to carry out one application, thus enabling individual users 40 on the network, i.e. individual users 40 on the data bus 10, to be woken selectively and in a targeted manner, to enable individual subnetworks to be formed in this way as and when required without the need for the whole network to be woken up.

For this purpose, the protocol controller unit 42 is advantageously used within the application for the addressing/activation analysis of the bit stream that is flowing. A separate current supply scheme for the protocol controller unit 42 and for the application controller unit 44 allows a significant reduction to be achieved in this case in the current consumption of the system 100.

A simple “handshake” mechanism between the physical connection to the data bus 10 and the serial protocol controller unit 42 is used to make the decision as to whether or not the local system is to wake up, that is to say is to be addressed and activated.

### LIST OF REFERENCE NUMERALS:

100 System
10 Data bus, in particular a C[ontroller] A[rea] N[etwork] data bus
12 Node on the data bus 10
20 Battery unit
21 Connection between battery unit 20 and first voltage regulator 32
26 Connection between battery unit 20 and second voltage regulator 36
30 Chip unit, in particular a system chip unit
32 First voltage regulator of chip unit 30
34 Transceiver unit of chip unit 30
36 Second voltage regulator of chip unit 30
40 User
42 Protocol controller unit
44 Application controller unit
52 First connection between transceiver unit 34 and protocol controller unit 42
54 Second connection between transceiver unit 34 and protocol controller unit 42
62 Connection between first voltage regulator 32 and protocol controller unit 42
70 Interface between transceiver unit 34 and application controller unit 44
82 Connection between second voltage regulator 36 and application controller unit 44
84 Reset line between second voltage regulator 36 and application controller unit 44
92 First connection between first voltage regulator 32 and transceiver unit 34
94 Second connection between first voltage regulator 32 and transceiver unit 34
96 Connection between transceiver unit 34 and second voltage regulator 36

1. A method of addressing and/or activating at least one user that is associated with at least one serial data bus, in particular a C[ontroller] A[rea] N[etwork] bus, and is intended to carry out at least one application, characterized in that, in the event of at least one incoming message occurring on the data bus, at least one protocol controller unit associated with the user is supplied with voltage first.

2. A method as claimed in claim 1, characterized
in that the protocol controller unit is addressed by the incoming message,
in that the incoming message is compared with at least one reference message that is associated with the application and is stored in the protocol controller unit.
in that if there is a correspondence and/or match between the incoming message and the reference message, at least one acknowledgement goes to at least one transceiver unit connected upstream of the user, and
in that the application, particularly at least one application controller unit associated with the user, is activated by the transceiver unit.

3. A method as claimed in claim 1, characterized in that the application, particularly the application controller unit, is only supplied with voltage if the incoming message and the reference message correspond and/or match.

4. A transceiver unit for carrying out a method as claimed in claim 1, characterized in that the transceiver unit
is connected to the data bus,
is in communication with the protocol controller unit, and
is in communication with the application controller unit.

5. A transceiver unit as claimed in claim 4, characterized by at least one set of control logic that is associated with the transceiver unit and/or is implemented in the transceiver unit

6. A first voltage regulator that is connected to at least one battery unit
and that is in communication with at least one transceiver unit, in particular a transceiver unit as claimed in claim 4, for supplying at least one protocol controller unit which is associated with at least one user provided for carrying out at least one application, with voltage in the event of at least one incoming message that occurs on at least one serial databus, in particular on at least one C[ontroller]A[rea]N[etwork] bus.

7. A second voltage regulator which is connected to at least one battery unit and which is in communication with at least one transceiver unit, in particular a transceiver unit as claimed in claim 4, which second voltage regulator is intended to supply voltage to at least one application controller unit, which is associated with at least one user provided for carrying out at least one application, in the event of a correspondence and/or match between at least one incoming message that occurs on at least one serial data bus, in particular on at least one C[ontroller]A[rea]N[etwork] bus, and at least one reference message stored in at least one protocol controller unit and associated with the application.

8. A chip unit, particularly a system chip unit, for addressing and/or activating at least one user that is associated with at least one data bus, in particular at least one C[ontroller] A[rea] N[etwork] bus, and is intended to carry out at least one application, characterized by
at least one transceiver unit as claimed in claim 4,
at least one first voltage regulator as claimed in claim 6, and
at least one second voltage regulator as claimed in claim 7.

9. A protocol controller unit for comparing at least one incoming message
which occurs on at least one serial data bus, in particular on at least one C[ontroller] A[rea] N[etwork] bus, with at least one stored reference message which is associated with at least one application to be carried out by at least one user, in particular by means of at least one message comparator and/or message filter, characterized in that in the event of one or more incoming messages, the protocol controller unit must be first supplied with a voltage.

10. A protocol controller unit as claimed in claim 9, characterized by at least
one timing generator, in particular a quartz unit, which enables the protocol controller unit to have timing of its own, in particular quartz timing.

11. An application controller unit which is to be supplied with voltage only
in the event of a correspondence and/or match between at least one incoming message that occurs on at least one serial data bus, in particular on at least one C[ontroller] A[rea] N[etwork] bus, and at least one stored reference message associated with at least one application to be carried out by at least one user.

12. (canceled)

13. (canceled)

14. (canceled)

15. (canceled)
